(19) United States
(12) Patent Application Publication
(10) Pub. No.: US 2009/0022058 A1
(43) Pub. Date: Jan. 22, 2009

(54) Method and System for Detecting and Reporting Faults of Data Transmission Equipment

(75) Inventors: Yong Li, Shenzhen (CN); Zhengchao Hu, Shenzhen (CN); Enchang Dong, Shenzhen (CN); Zhenyu Tang, Shenzhen (CN)

Correspondence Address: HARNESS, DICKEY & PIERCE, P.L.C., P.O. BOX 828, BLOOMFIELD HILLS, MI, 48303, US

(73) Assignee: Huawei Technologies Co., Ltd., Shenzhen (CN)

(21) Appl. No.: 12/239,349

(22) Filed: Sep. 26, 2008

Related U.S. Application Data
(63) Continuation of application No. PCT/CN2007/000990, filed on Mar. 27, 2007.

(30) Foreign Application Priority Data
Mar. 27, 2006 (CN) 200610067409.0

(51) Int. Cl. H04L 12/26

(52) U.S. Cl. 370/242

(57) ABSTRACT

A method and a system for detecting and reporting faults of data transmission equipment. The method includes: detecting the fault causes of the local data transmission equipment, sending the detected fault causes and important state information of the local data transmission equipment to the peer data transmission equipment, and identifying the received fault causes and important state information and reporting them to the NMS.

### CROSS-REFERENCE TO RELATED APPLICATIONS

This application is a continuation of International Application No. PCT/CN2007/000990, filed Mar. 27, 2007. This application claims the benefit and priority of Chinese Application No. 200610067409.0, filed Mar. 27, 2006. The entire disclosures of each of the above applications are incorporated herein by reference.

### FIELD

The present disclosure relates to the network operation and maintenance field and to a method and a system for detecting and reporting faults of data transmission equipment.

### BACKGROUND

This section provides background information related to the present disclosure which is not necessarily prior art.

In the prior art, the network transmission of network equipment is vulnerable to interruption due to link failure or power failure. Network equipment generally has a dedicated channel for data interaction with the Network Management System (NMS) or has the function of transmitting interaction information through traffic overhead, thus implementing network management and monitoring.

However, once the network fails, it is usually difficult to know whether the network failure is caused by power failure, equipment failure or link failure. Link failure includes fiber cut and coax cable fault.

In order to locate the fault quickly and recover the communication effectively, and prevent the network maintainers from regarding mistakenly power failure as equipment failure or cable fault, it is required to identify power failure effectively and, provide accurate and rich equipment maintenance information to the equipment users.

For example, a piece of equipment is installed tens of kilometers away, and is connected with the local equipment through fibers. Without additional communication means, it is not possible to know whether the remote equipment is power off or not. When the remote equipment powers off, the local equipment can detect signal loss, but is unable to know whether the signal loss is caused by fiber cut or equipment power failure, or to obtain the information about equipment power failure.

In order to obtain the information about power failure of the remote equipment, the prior art uses a dedicated power detection device and a dedicated auxiliary communication circuit, both relying on a standby power supply (such as battery) to work. The solution provided by the prior art requires additional auxiliary communication means, brings higher costs and is unable to be integrated with the NMS of the communication equipment.

### SUMMARY

This section provides a general summary of the disclosure, and is not a comprehensive disclosure of its full scope or all of its features.

A method and a system for detecting and reporting faults of data transmission equipment provided in an embodiment can detect the fault causes of the network equipment and report in real time, so that the NMS can handle the network equipment faults during the data transmission timely and accurately.

An embodiment provides a method for detecting and reporting faults of data transmission equipment, including:

detecting the fault causes of the local data transmission equipment; and

sending the detected fault causes and the important state information of the local data transmission equipment to the peer data transmission equipment.

An embodiment further provides data transmission equipment, including:

a fault cause detecting module, adapted to detect the fault causes of the local data transmission equipment; and

a fault cause sending module, adapted to send the detected fault causes and the important state information of the local data transmission equipment to the peer data transmission equipment.

An embodiment further provides a data transmission equipment, including:

a peer fault cause identifying module, adapted to identify the received fault causes and important state information of the peer data transmission equipment; and

a reporting module, adapted to report the identified fault causes and important state information of the peer data transmission equipment to the NMS.

An embodiment further provides a system for detecting and reporting faults of data transmission equipment, including:

a first data transmission equipment, adapted to send the detected fault causes and important state information of the local data transmission equipment; and

a second data transmission equipment, adapted to identify the received fault causes and important state information of the first data transmission equipment and report them to the NMS.

In the present disclosure, the local data transmission equipment detects its own fault causes, and sends the detected fault causes and important state information of the local data transmission equipment to the peer end, thus overcoming the trouble of using an additional detection device to detect the fault causes in the prior art. Without auxiliary communication means, the maintainers can know the information about faults of the peer communication equipment, thus improving maintainability of the communication equipment.

The fault causes are not reported to the NMS directly, but through the peer data transmission equipment. As a result, the reporting is fast, and the NMS can handle the network equipment faults during the data transmission timely and accurately. Moreover, since the fault causes are not reported to the NMS directly, the channel of transmitting messages can be selected at discretion. It is appropriate to select the dedicated data link for transmitting NMS messages (for example, transmitting DCC bytes of the MSTP equipment), or select the data link previously used for data transmission (for example, transmitting various payloads of the MSTP equipment such as VC4, VC3, and VC12).

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows the structure of a system for detecting and reporting faults of data transmission equipment in which the fault causes are transmitted through a normal data transmitting/receiving port according to an embodiment.

FIG. 2 shows the structure of a system for detecting and reporting faults of data transmission equipment in which the fault causes are transmitted through a dedicated port according to an embodiment.

FIG. 3 shows a flowchart of a method for detecting and reporting faults of data transmission equipment according to an embodiment.

FIG. 4 shows the structure of a system for detecting and reporting faults of data transmission equipment in which the fault causes (power failure) are transmitted through a normal data transmitting/receiving port according to an embodiment.

FIG. 5 shows the structure of a system for detecting and reporting faults of data transmission equipment in which the fault causes (power failure) are transmitted through a dedicated port according to an embodiment.

FIG. 6 shows the time sequence from detecting voltage fall to main voltage failure of the system according to an embodiment.

FIG. 7 shows the structure of a system for detecting and reporting faults of data transmission equipment in an Ethernet according to an embodiment.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

The accompanying drawings are intended for better understanding of the present disclosure and constitute part of this application. The exemplary embodiments and description about them are intended for interpreting rather than limiting the present disclosure. The present disclosure is hereinafter described in detail with reference to accompanying drawings.

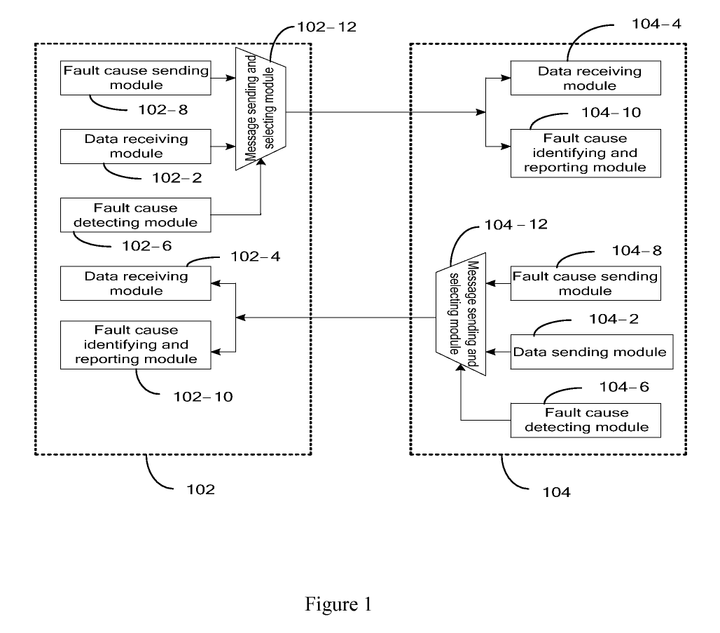

FIG. 1 shows the structure of a system for detecting and reporting faults of data transmission equipment in which the fault causes are transmitted through a normal data transmitting/receiving port according to an embodiment.

As shown in FIG. 1, in this embodiment, the local data transmission equipment 102 includes a data transmitting module 102-2 and a data receiving module 102-4, and further includes:

a fault cause detecting module 102-6, adapted to detect the fault causes of the local data transmission equipment;

a fault cause sending module 102-8, adapted to share a port with the data sending module 102-2 when a fault cause is detected, make a selection through the message sending selection module 102-12, and send the detected fault causes and important state information of the local data transmission equipment to the peer data transmission equipment through fibers, cables or RF; and

a fault cause identifying and reporting module, adapted to identify the fault causes and important state information from the peer data transmission equipment, and report the identified fault causes and important state information of the peer data transmission equipment to the NMS.

Likewise, in this embodiment, the peer data transmission equipment 104 includes a data transmitting module 104-2 and a data receiving module 104-4, and further includes:

a fault cause detecting module 104-6, adapted to detect the fault causes of the data transmission equipment;

a fault cause sending module 104-8, adapted to share a port with the data sending module 104-2 when a fault cause is detected, make a selection through the message sending selection module 104-12, and send the detected fault causes and important state information of data transmission equipment to the local data transmission equipment through fibers, cables or RF; and

a fault cause identifying and reporting module 104-10, adapted to identify the fault causes and important state information from the local data transmission equipment, and report the identified fault causes and important state information of the local data transmission equipment to the NMS.

The fault cause sending module keeps normal work through an energy conservation component or a standby power supply of the data transmission equipment. Before failure of working normally, the fault cause sending module sends out the fault causes and important state information completely. The fault cause sending module can send fault causes and important state information through a normal data transmitting port or a dedicated port of the data transmission equipment.

The fault cause sending module can send fault causes and important state information in at least one of the following modes:

sending fault causes and important state information through an operation management and maintenance channel; and

adding the fault causes and important state information into the payload, which will be transmitted to the peer data transmission equipment.

Fault causes include power failure of data transmission equipment. The fault cause detecting module detects whether the voltage of the main power supply or internal power supply of the data transmission equipment falls. If the voltage falls, the fault cause is power failure of data transmission equipment.

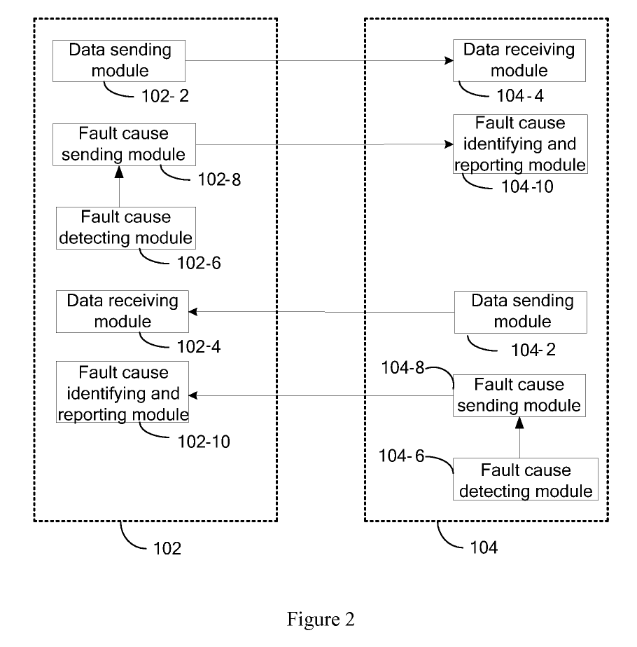

FIG. 2 shows the structure of a system for detecting and reporting faults of data transmission equipment in which the fault causes are reported through a dedicated data transmitting/receiving port in an embodiment.

As shown in FIG. 2, in this embodiment, the local data transmission equipment 102 includes a data transmitting module 102-2 and a data receiving module 102-4, and further includes:

a fault cause detecting module 102-6, adapted to detect the fault causes of the local data transmission equipment;

a fault cause sending module 102-8, adapted to send the detected fault causes and important state information of the local data transmission equipment through a dedicated port to the peer data transmission equipment through fibers, cables or RF when a fault cause is detected; and

a fault cause identifying and reporting module, adapted to: identify the fault causes and important state information from the peer data transmission equipment; and report the identified fault causes and important state information of the peer data transmission equipment to the NMS.

Likewise, in this embodiment, the peer data transmission equipment 104 includes a data transmitting module 104-2 and a data receiving module 104-4, and further includes:

a fault cause detecting module 104-6, adapted to detect the fault causes of the data transmission equipment;

a fault cause sending module 104-8, adapted to send the detected fault causes and important state information of the local data transmission equipment through a dedicated port to the local data transmission equipment through fibers, cables or RF when a fault cause is detected; and

a fault cause identifying and reporting module 104-10, adapted to: identify the fault causes and important state information from the local data transmission equipment; and report the identified fault causes and important state information of the local data transmission equipment to the NMS.

The fault cause sending module keeps normal work through an energy conservation component or a standby power supply of the data transmission equipment. Before failure of working normally, the fault cause sending module sends out the fault causes and important state information completely. The fault cause sending module can send fault causes and important state information through a normal data transmitting port or a dedicated port of the data transmission equipment.

The fault cause sending module can send fault causes and important state information in at least one of the following modes:

sending fault causes and important state information through an operation management and maintenance channel; and

adding the fault causes and important state information into the payload, which will be transmitted to the peer data transmission equipment.

Fault causes include power failure of data transmission equipment. The fault cause detecting module detects whether the voltage of the main power supply or internal power supply of the data transmission equipment falls. If the voltage falls, the fault cause is power failure of data transmission equipment.

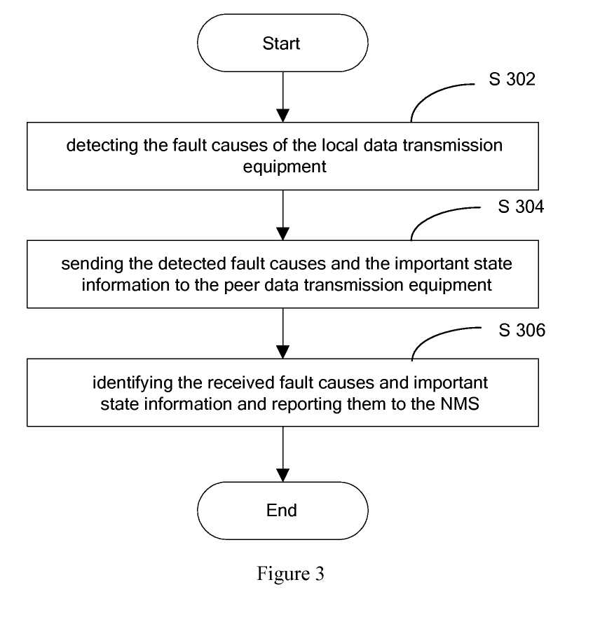

FIG. 3 is a flowchart of a method for detecting and reporting faults of data transmission equipment according to an embodiment.

As shown in FIG. 3, in this embodiment, the method for detecting and reporting faults of data transmission equipment includes.

S302: through a fault cause detecting module, detecting the fault causes of the local data transmission equipment.

S304: through a fault cause sending module, sending the detected fault causes and the important state information of the local data transmission equipment to the peer data transmission equipment.

S306: through a fault cause identifying and reporting module, identifying the fault causes and important state information from the peer data transmission equipment, and reporting the identified fault causes and important state information of the peer data transmission equipment to the NMS.

The fault cause sending module keeps normal work through an energy conservation component or a standby power supply of the data transmission equipment. Before failure of working normally, the fault cause sending module sends out the fault causes and important state information completely. The fault cause sending module can send fault causes and important state information through a normal data transmitting port or a dedicated port of the data transmission equipment.

The fault cause sending module can send fault causes and important state information in at least one of the following modes:

sending fault causes and important state information through an operation management and maintenance channel; and

adding the fault causes and important state information into the payload, which will be transmitted to the peer data transmission equipment.

The fault cause identifying and reporting module can receive fault causes and important state information through a normal data receiving port or a dedicated port of the data transmission equipment.

Fault causes include power failure of data transmission equipment. The fault cause detecting module detects whether the voltage of the main power supply or internal power supply of the data transmission equipment falls. If the voltage falls, the fault cause is power failure of data transmission equipment.

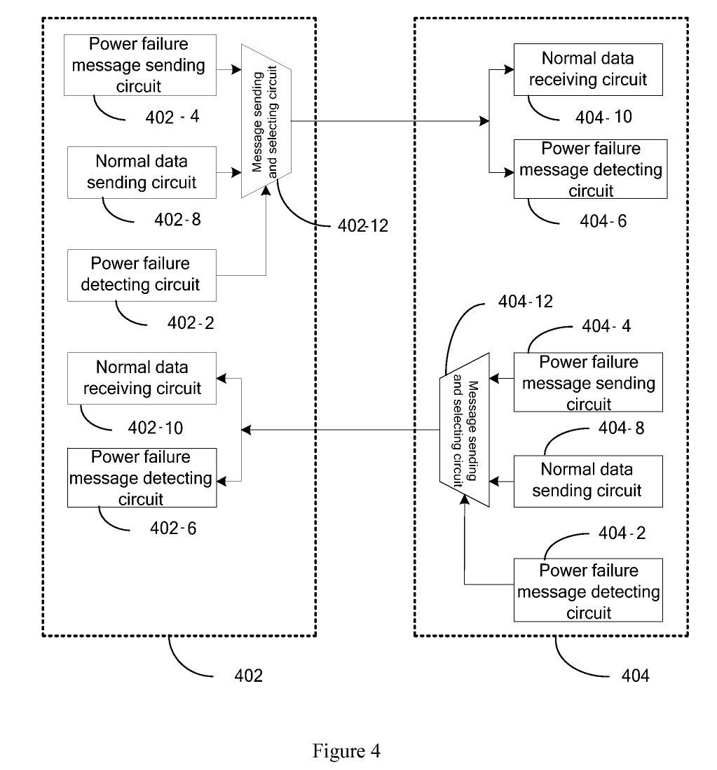

FIG. 4 shows the structure of a system for detecting and reporting faults of data transmission equipment in which the fault causes (power failure) are transmitted through a normal data transmitting/receiving port according to an embodiment.

As shown in FIG. 4, both the local data transmission equipment 402 and the peer data transmission equipment 404 include normal data transmitting circuits 402-8 and 404-8 as well as normal data receiving data 402-10 and 404-10.

In the case that the fault cause is power failure of data transmission equipment, both the local data transmission equipment and the peer data transmission equipment must have power failure detecting circuits 402-2 and 404-2, which are adapted to detect the fall of supply voltage. The fall of supply voltage serves as a basis for judging imminent power failure of the network equipment.

Circuits (or software) 402-4 and 404-4 adapted to send messages must be available.

Circuits (or software) 402-6 and 404-6 adapted to receive and identify power failure messages (power failure detection) must be available.

After the power failure detecting circuit detects voltage fall, it indicates that the network equipment is about to incur power failure, and the message sending circuit (or software) can send important state information of the equipment quickly.

Messages are sent to the peer network equipment, converted by the peer network equipment, and then sent to the NMS.

When a message is sent to the NMS directly, it takes a relatively long time, and a dedicated energy conservation unit is required. When a message is sent to the peer Network Element (NE) directly, it takes much less time than being sent to the NMS directly.

The message sent upon power failure is not sent to the NMS directly, so the channel for transmitting the message can be selected flexibly, without being limited to the dedicated Operation Administration and Maintenance (OAM) channel (for example, in the case of transmitting SOH bytes of the equipment in a multi-service transfer platform). The message can also be put into the payload for transmitting.

When a voltage fall detection circuit detects voltage fall, the message sending circuit can keep working normally by using the energy conservation component, but not limited to the standby power supply, of the equipment.

The word “quickly” mentioned above implies that the message of power failure of the equipment or other important information of the equipment should be sent out completely before the message sending circuit fails.

The ports for sending and receiving messages include, but are not limited to, the normal data sending and receiving port, and may be a dedicated port, which is exclusively adapted to send and receive power failure messages.

Power failure messages may be specific bit sequences, codes or data packets. Such specific bit sequences, codes and data packets have distinct features, and are easily detectible by the message detecting circuit or software. Power failure messages should be different from normally transmitted data so that the detecting circuit will not mistakenly regard the normally transmitted data as power failure messages.

Reported messages are not limited to power failure messages, and may be important state messages of other equipment.

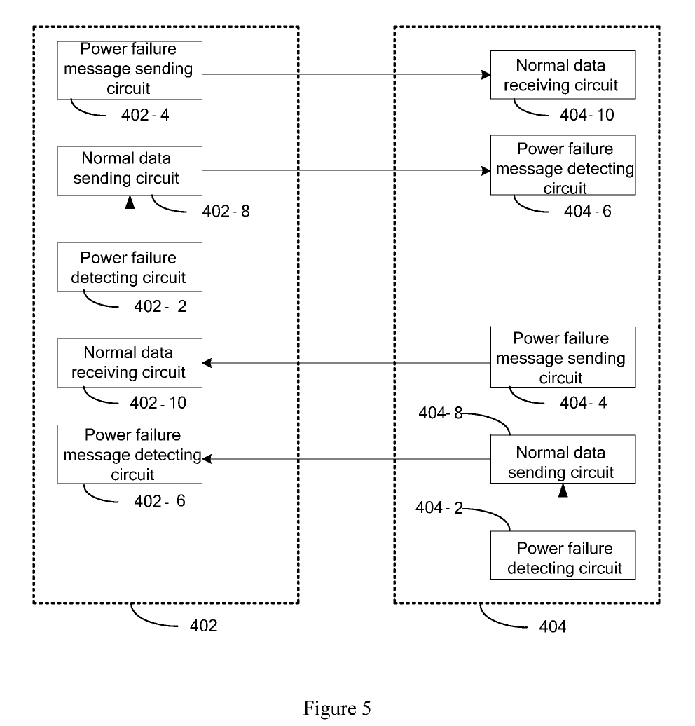

The transmission process may be the circumstance in FIG. 4, in which the data port for sending/receiving power failure messages is the same as the data port for sending/receiving normal data, or the circumstance in Figure 5, in which a dedicated port is used for sending/receiving power failure messages. However, the transmission process is not limited to the previous two circumstances.

FIG. 5 shows the structure of a system for detecting and reporting faults of data transmission equipment in which the fault causes (power failure) are transmitted through a dedicated port according to an embodiment.

After the power failure detecting circuit of the local data transmission equipment 402 detects power failure of the local data transmission equipment, the power failure message sending circuit sends the power failure message through a dedicated port to the power failure message detecting circuit of the peer data transmission equipment 404 directly.

Likewise, after the power failure detecting circuit of the peer data transmission equipment detects power failure of the peer data transmission equipment, the power failure message sending circuit sends a power failure message through a dedicated port to the power failure detecting circuit of the local data transmission equipment directly.

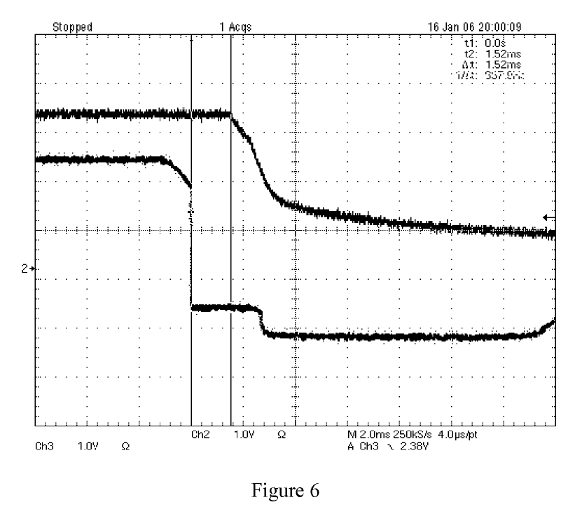

FIG. 6 shows the time sequence from detecting voltage fall to main voltage failure of the system according to an embodiment. FIG. 6 is an example of time sequence of the MSTP equipment from detecting voltage fall to main voltage failure of the system in the process of detecting and reporting power failure on MSTP equipment.

The waveform in FIG. 6 is the working voltage of the power failure message sending circuit, and the following waveform is the power failure signal output by the power failure detecting circuit, where low levels are effective.

The time interval from the event that the power failure detecting circuit outputs an effective power failure signal to the event that the working voltage of the message sending circuit begins falling is about 1.5 ms. Namely, for the specific equipment, the power failure message must be sent out within 1.5 ms. On the MSTP equipment, the power supply used by the chip on a board is generally 1.2 V˜3.3 V, and the power failure detection may be performed at the input 220 VAC/110 VAC or −48 VDC/24 VDC side. If the power supply is backed up in a 1+1 backup mode, the power failure detection is performed at the place where the power supply is closed. In this way, the power failure detecting circuit detects the power failure of the equipment rather than the power failure of the input power supply.

For reducing costs, backup power supply for the exclusive purpose of sending power failure messages is usually lacking. The power failure message may be put into the specific byte of the SOH such as DCC byte (D1˜D12) for transmitting. After power failure is detected, the specific byte begins to send special bit sequences such as PRBS.

In order to reduce the probability of mistakenly detected power failure messages, the length of a special bit sequence should be greater than 32 bits. If a PRBS is selected for transmitting power failure messages, the selected PRBS should be different from the PRBS of ordinary instruments. In this way, the power failure message receiving circuit will not mistakenly detect the power failure message during a test performed through an instrument.

The power failure message receiving circuit detects special bit sequences, and reports NE power failure to the peer side after detecting a special bit sequence.

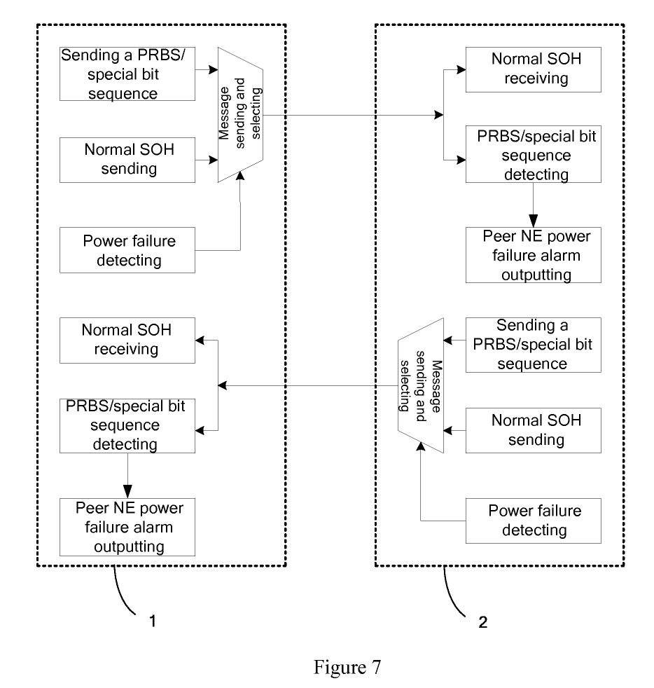

The schematic diagram is given in FIG. 7. FIG. 7 shows the structure of a system for detecting and reporting faults of data transmission equipment in an Ethernet according to an embodiment.

The power failure detecting circuit of NE1 detects whether the power supply of NE1 fails. If the detection result indicates power failure, the message sending and selecting circuit selects to send a PRBS/special bit sequence, and sends out the PRBS/special bit sequence completely before the sending circuit fails. The detecting circuit of NE2 detects the PRBS/special bit sequence, and outputs the power failure alarm of NE1 to the NMS after detecting a PRBS/special bit sequence.

Likewise, the power failure detecting circuit of NE2 detects whether the power supply of NE2 fails. If the detection result indicates power failure, the message sending and selecting circuit selects to send a PRBS/special bit sequence, and sends out the PRBS/special bit sequence completely before the sending circuit fails. The detecting circuit of NE1 detects the PRBS/special bit sequence, and outputs the power failure alarm of NE2 to the NMS after detecting a PRBS/special bit sequence.

On an Ethernet device, the message that needs to be reported at the time of power failure can be encapsulated into an Ethernet packet as part of the OAM information.

Through the embodiments, the maintainers can obtain the information about power failure of the peer communication equipment without any auxiliary communication means. In the case of service interruption, the maintainers can additionally know whether the service interruption is caused by power failure. The communication equipment is more maintainable. The message sent in the case of power failure is not reported to the NMS directly, but is sent to the peer equipment; and then the peer equipment reports the message to the NMS, which speeds up the reporting. Moreover, since the fault causes are not reported to the NMS directly, the channel of transmitting messages can be selected at discretion. It is appropriate to select the dedicated data link for transmitting NMS messages (for example, transmitting DCC bytes of the MSTP equipment), or select the data link previously used for data transmission (for example, transmitting various payloads of the MSTP equipment such as VC4, VC3, and VC12).

The embodiments described above are not meant to confine the protection scope of this disclosure. The technicians in this field may make various changes and variations to the present disclosure. It is apparent that those skilled in the art can make various modifications and variations to the disclosure without departing from the spirit and scope of the disclosure. The disclosure is intended to cover the modifications and variations provided that they fall in the scope of protection defined by the following claims or their equivalents.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for detecting and reporting faults of data transmission equipment, comprising:
detecting the fault causes of the local data transmission equipment;
sending the detected fault causes and the important state information of the local data transmission equipment to the peer data transmission equipment.

2. The method of claim 1, wherein the detected fault causes and the important state information of the local data transmission equipment are sent to the peer data transmission equipment before the local data transmission equipment is unable to send data normally.

3. The method of claim 1, wherein the procedure of sending the detected fault causes and the important state information of the local data transmission equipment to the peer data transmission equipment comprises:
sending fault causes and important state information to the general data receiving port and/or dedicated data receiving port of the peer data transmission equipment through the OAM channel, general data sending port and/or dedicated data sending port of the local data transmission equipment; or
adding the fault causes and important state information into the payload, which will be sent to the peer data transmission equipment.

4. The method according to any one of claim 1, wherein the fault causes include power failure of the local data transmission equipment.

5. The method of claim 4, wherein the procedure of detecting the fault causes of the local data transmission equipment comprises:
detecting whether the voltage of the main power supply and/or internal power supply of the local data transmission equipment falls. If the voltage falls, the fault cause is power failure of the local data transmission equipment.

6. The method of claim 1, further comprising:
receiving, by the peer data transmission equipment, the detected fault causes and the important state information of the local data transmission equipment;
identifying the received fault causes and important state information and reporting them to the NMS.

7. A type of data transmission equipment, comprising:
a fault cause detecting module, adapted to detect the fault causes of the local data transmission equipment; and
a fault cause sending module, adapted to send the detected fault causes and the important state information of the local data transmission equipment to the peer data transmission equipment.

8. The data transmission equipment of claim 7, further comprising a sending power supply, adapted to supply power to the fault cause sending module to maintain normal working, wherein the fault cause sending module sends out the fault causes and important state information before the sending power supply stops supplying power.

9. The data transmission equipment of claim 8, wherein the sending power supply comprises an energy conservation component and/or a standby power supply of the local data transmission equipment.

10. The data transmission equipment of claim 8, wherein the fault cause detecting module comprises:
an input unit, adapted to output voltage of the main power supply and/or internal power supply through connection with the main power supply and/or internal power supply of the local data transmission equipment; and
a judging unit, adapted to output the information indicating that the fault cause is power failure of the local data transmission equipment if the voltage of the main power supply and/or internal power supply falls.

11. The data transmission equipment of claim 8, wherein the output side of the fault cause sending module is connected with the OAM channel, the general data sending port and/or the dedicated data sending port of the local data transmission equipment.

12. The data transmission equipment of claim 8, wherein the input side of the fault cause sending module further inputs the payload transmitted to the peer data transmission equipment, and the fault cause sending module adds the fault causes and important state information into the payload which will be sent to the peer data transmission equipment.

13. A type of data transmission equipment, comprising:
a peer fault cause identifying unit, adapted to identify the received fault causes and important state information of the peer data transmission equipment; and
a reporting unit, adapted to report the identified fault causes and important state information of the peer data transmission equipment to the NMS.

14. The data transmission equipment of claim 13, wherein the input side of the peer fault cause identifying unit is connected with the general data receiving port and/or the dedicated data receiving port of the local data transmission equipment.

15. A system for detecting and reporting faults of data transmission equipment, comprising:
a first data transmission equipment, adapted to send the detected fault causes and important state information of the local data transmission equipment; and
a second data transmission equipment, adapted to identify the received fault causes and important state information of the first data transmission equipment, and report them to the NMS.
